(19) United States
(12) Patent Application Publication
(10) Pub. No.: US 2005/0126150 A1
(43) Pub. Date: Jun. 16, 2005

(54) Crop stripping apparatus & method

(75) Inventors: Andrew J. Talbott, Hudson, WI (US); Douglas Ahrens, Clear Lake, WI (US); Tylor Cain, Clear Lake, WI (US)

Correspondence Address: MERCHANT & GOULD PC, P.O. BOX 2903, MINNEAPOLIS, MN, 55402-0903, US

(73) Assignee: Oxbo International Corporation, Clear Lake, WI (US)

(21) Appl. No.: 10/738,915

(22) Filed: Dec. 16, 2003

(51) Int. Cl. A01D 45/02

(52) U.S. Cl. 56/103

(57) ABSTRACT

A harvesting method for plants provides for harvesting one portion of the plant having a first nutritional content separately from the second portion of the plant having a second nutritional content. Desired nutritional contents may be achieved by varying the ratio of the two plant portions. The leaves of the plant often have higher protein content than the stems and may be stripped from the stems and harvested separately from the stems. Leaves may be allowed to regrow or the stems may be harvested at the same time. The mixing and matching of times of harvested leaves and stems, various ratios may be achieved. In addition, a percentage of the leaves may be removed and or the time that the leaves regrow may be varied to achieve the desired characteristics.

### BACKGROUND OF THE INVENTION

1. Field of the Invention

The present invention relates to methods for harvesting crops and in particular to methods of harvesting and managing crops by stripping the leaves of the crop, such as alfalfa, and harvesting the leaves separately from the stems, providing for combining the stems and leaves in a controlled manner to achieve desired nutrient contents.

2. Description of the Prior Art

Current methods for harvesting a crop such as alfalfa, typically involve simply cutting the crop and allowing it to dry in the field. The time required for sufficient drying is usually several days, but problems are often encountered when wet or humid conditions exist, adversely affecting drying time and material quality. When dried, the crop is picked up by a forage harvester or other pick up devices and the material may be chopped and blown into trucks, wagons or carts. The material is then transported to bunker-type silos, upright silos or pressed into bags and stored for later feeding. The haylage is a convenient food source for livestock during the winter months. In a typical growing season, multiple cuttings occur.

Current harvesting and managing processes combine the leaves and stems, which are chopped together, and fed as a mixture to livestock. The stems and the leaves of alfalfa have different properties and nutrient values, particularly with regard to protein content. The stems have a relatively low protein content while the leaves have a protein content of up to 30%. For some feeding requirements, the naturally occurring ratio of leaves to stems may be satisfactory. However, for other feeding requirements, higher protein values may be preferred. In particular, for management of a dairy herd, the farmer may choose to feed cows that are high milk producers a feed that has higher protein content. Heretofore, in order to increase the protein content, it has been necessary to add protein supplements to the feed mix. Animals that may need higher fiber content and lower protein content have received the same mixture of stems and leaves as animals needing a higher protein mixture, but in some instances, without the protein supplement.

It can be appreciated that if the leaves and stems are separately harvested, farmers are better able to match the protein requirements of the livestock with their feed by changing the percentages of stems and leaves that are fed to various livestock. Moreover, if the leaves and stems are harvested separately or a portion of the leaves is harvested separately, particular nutrient levels may be achieved without any post harvesting mixing.

It can be appreciated that a new and improved method is needed for harvesting a crop and matching the nutritional needs of the livestock to which it is being fed with the content as harvested without supplements. Such a method should provide for separately harvesting portions of the crop with different nutritional content and allowing such different portions to be mixed in a controlled manner at a later time to achieve the desired content. Moreover, reharvesting some portion of the crop or harvesting only a portion of the crop may achieve a greater range of content. Such a range is achieved without requiring mixing after harvesting and without requiring supplements to arrive at the desired content. The present invention addresses these as well as other problems associated with harvesting a crop and achieving feed content objectives.

### SUMMARY OF THE INVENTION

The present invention is directed to methods of harvesting crops to maximize desired nutritional traits in a feed mix. In certain crops, such as alfalfa, various portions of each plant have different nutritional values. With alfalfa, for example, the stems have relatively low protein content but higher fiber content, while the leaves have a relatively high protein content and lower fiber content. Rather than feeding and harvesting the entire plant at one time, it can be appreciated that if portions having different nutritional contents are harvested separately, these may be mixed in different proportions to arrive at a final feed product that has desired nutritional content. Various mixtures having various contents may be achieved without adding supplements, as is required with the prior art.

A harvester is configured to strip leaves from plants while leaving the stems standing during selected harvesting operation. The harvester typically has a reel with tines extending there from configured to engage the plants and remove leaves. The harvester may be configured to vary the amount of leaves removed from the stem. By allowing a varied amount of leaves to be removed, the mixture of leaves and stems may be varied in a more precise manner. It is envisioned that different tines or reels may be utilized, the number of tines may be varied, or the harvester or reel speed may be varied to change the percentage of leaves that are removed. The harvester or a different implement is utilized to cut and harvest the stems through selected harvesting operations.

In a first method, leaves or a percentage of the leaves are removed while the stems are left standing. The stems may then be harvested later and separately from the leaves. It has been found that plants with the leaves removed will dry faster so that the stems may be sufficiently dry for harvesting within one day. Such a method provides for removal of leaves in the morning and harvesting of the stems later in the same day.

In a variation of this method, the stems may be cut after the leaves have been removed and allowed to dry in the field after being cut. The stems are then picked up separately from the leaves. Such a method provides for drying of the stems without the leaves. It has been found that cut stems dry sufficiently within one day after the leaves have been removed so that after the leaves are removed and the stems cut in the morning and the stems can be harvested later in the same day.

The stems are not cut in a further variation of the harvesting and the leaves are allowed to regrow one or more times. The leaves may then be harvested and reharvested to achieve an often desirable higher leaf to stem ratio. It has been found that leaves regrow faster than cut plants regrow stems and leaves, so that additional harvestings of leaves may be accomplished as compared to cutting the entire plant, as was done with the prior art methods. In addition, greater control over the variability may be accomplished by allowing the leaves to grow for longer or shorter periods. Varying the growing periods increases or decreases the total mass of the leaves and the overall ratio leave to stem ratio.

In a further aspect of the invention, at the end of the growing season, the leaves are stripped while the stems are left standing. The stems may act as a snow collector to help insulate the plants as well as to retain additional moisture in the field. Due to the shorter time needed to regrow only leaves, a final harvesting of just leaves may provide an additional harvesting as compared to prior art methods wherein the entire plant was harvested.

It can be appreciated that various aspects of the invention may be combined to achieve a harvested product that has desired nutritional or other content. By varying and combining the various aspects of the invention, a wide range of harvested product having a different ratio of harvested portions may be achieved.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring now to the drawings, wherein like reference letters and numbers indicate corresponding structure throughout the several views:

FIG. 1 is a side elevational view of a plant having all leaves and stems attached;

FIG. 2 is a side elevational view of a plant with leaves removed;

FIG. 3 is a side elevational view of a plant with some of the leaves removed;

FIG. 4 is a flow diagram of a first harvesting method according to the principles of the present invention;

FIG. 5 is a flow diagram of a second harvesting method according to the principles of the present invention;

FIG. 6 is a flow diagram of a third harvesting method according to the principles of the present invention;

FIG. 7 is a flow diagram of a fourth harvesting method according to the principles of the present invention;

FIG. 8 is a flow diagram of a fifth harvesting method according to the principles of the present invention; and

FIG. 9 is a side elevational view of a harvesting reel for stripping leaves according to the principles of the present invention.

### DETAILED DESCRIPTION OF THE PREFERRED EMBODIMENT

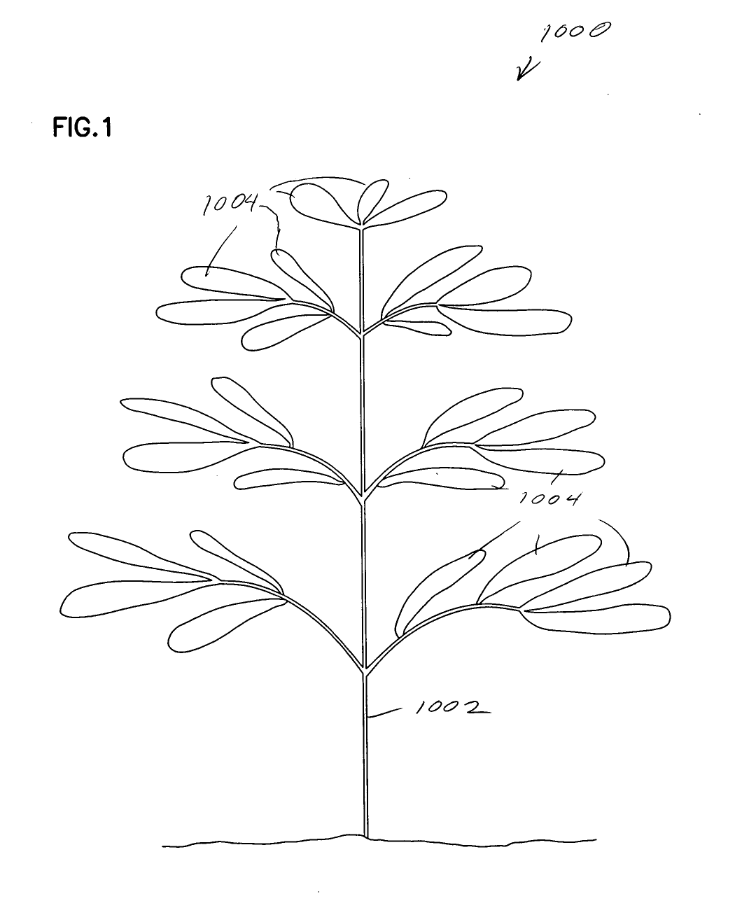

Referring now to the drawings, and in particular to FIGS. 1-3, there is shown a typical plant crop, generally designated 1000. The plant crop 1000 may be alfalfa or other similar type crops having a different content between the stem 1002 and the leaves 1004. It can be appreciated that growers of plants such as mint, grain crops including barley, and others might also benefit from the harvesting and management methods of the present invention. In some plants used for livestock feed, such as alfalfa, the leaves 1004 have different nutritional content than the stems 1002. In particular, the protein content of the leaves 1004 is typically much higher than that of the stems 1002. In addition, stems 1002 typically have a higher fiber content than the leaves 1004. By harvesting the leaves 1004 separately from the stems 1002, the harvested material may be controllably mixed to achieve desired nutritional contents by varying the percentages of leaves 1004 and stems 1002. Using only leaves 1004 or a mixture containing a higher percentage of leaves 1004 than stems 1002 achieves higher protein content. Conversely, for livestock that may require lower protein content, the feed mixture may be only stems 1002 or a mixture having a higher percentage of stems 1002 than leaves 1004. In addition, percentages and content may be varied within a mixture ranging from only stems to only leaves. Such mixing and matching of nutritional content to the needs of particular animals provides for elimination of supplements and optimization of nutritional content of feed to the needs of the animals. Moreover, within a single herd, certain animals may receive a particular mixture while others receive a mixture having a different content.

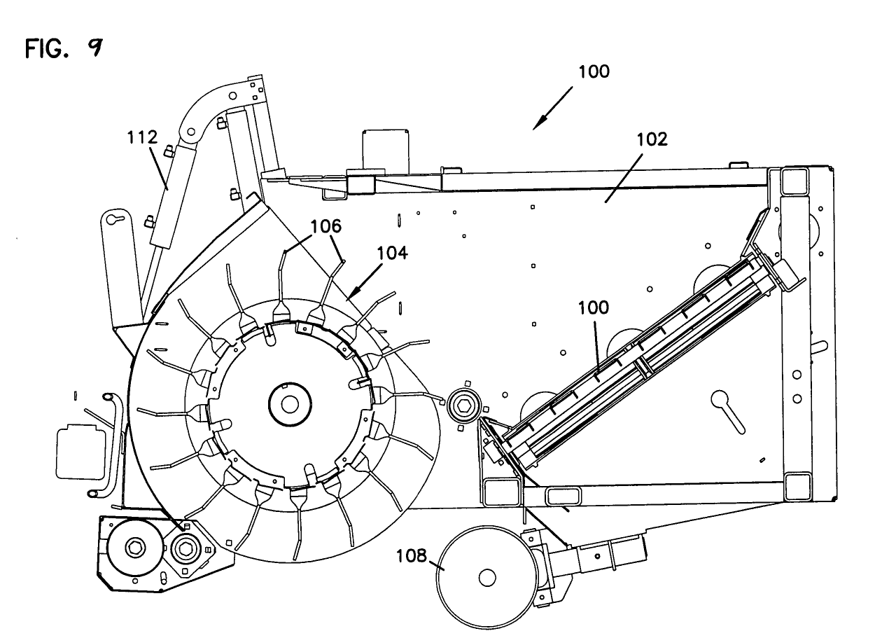

Referring now to FIG. 9, there is shown a harvester, generally designated 100, utilized for stripping leaves off of plants, such as alfalfa. It can be appreciated that other harvesters having different configurations that provide for stripping leaves while leaving the stems could also be utilized. Moreover, for some aspects of the present invention, it may be possible to use a separator that harvests both stems and leaves, but provides for separation of the leaves and the stems.

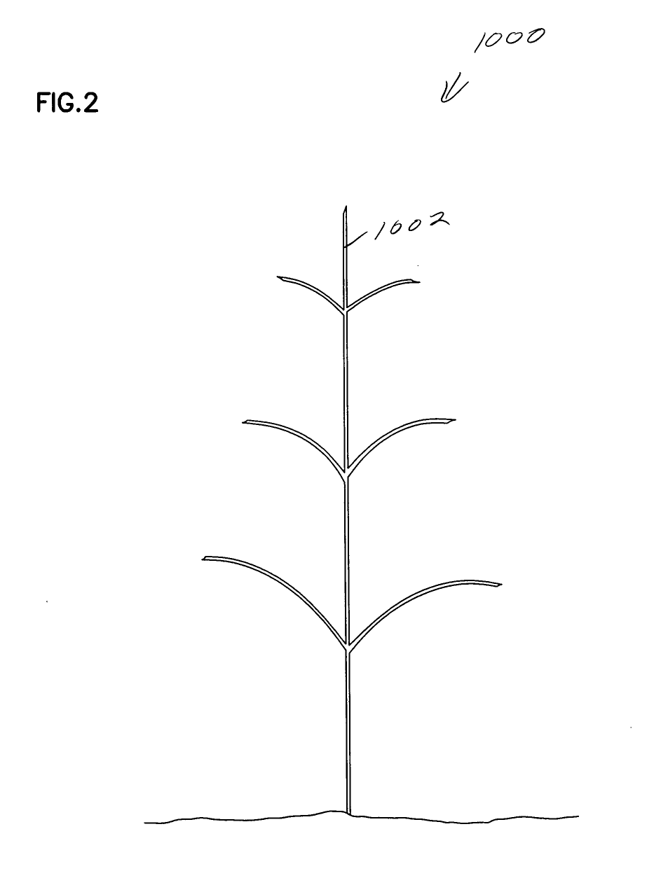

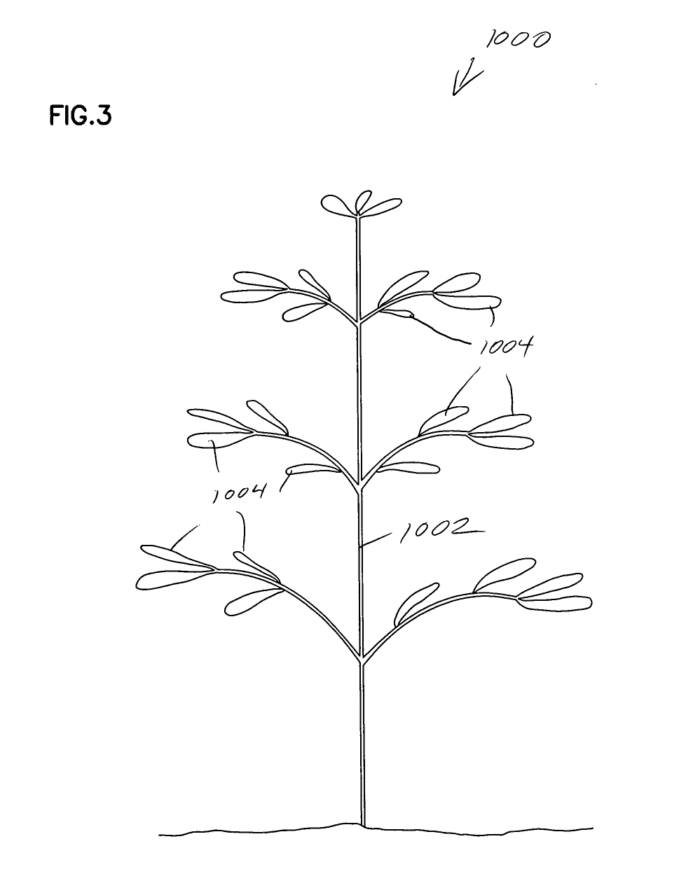

The harvester 100 generally includes a frame 102 supporting a harvesting reel 104. The reel 104 includes a multiplicity of tines 106 extending radially outward from a periphery of the reel 104 and spaced laterally along the length of the harvesting reel 104. The tines 106 generally have some flexure and may have flexible mounts to slightly pivot on the reel 104. Other types of tines 106 or engagement elements that are configured for stripping leaves, while leaving the stems of plants may also be utilized. The harvester 100 also includes support wheels 108 and a reel adjustment mechanism 112 for maintaining the reel 104 at the proper height relative to the ground and to avoid rocks and other obstacles that may be encountered as the harvester 100 moves across a field. The harvester includes a transport system generally designated 110 that may include belt conveyors, augers or other conventional transporters that receive harvested material from the reel 104 and move it to a hold, wagon or truck. The harvester 100 may also include separators for separating the stems and the leaves of plants as may be necessary. For some configurations, the reel 104 may not cut the stems of the plants and a cutting bar or other widely used cutting device is positioned on the harvester 100 remote from the reel 104. It can be appreciated that the operation of the reel 104 may be modified to vary the percentage of leaves that are stripped from the plant. The type and number of tines 104 may be reconfigured so that fewer or more leaves are harvested. In some embodiments, it is preferred to strip all leaves as shown in FIG. 2, while in others, only a certain percentage may be removed to leave some of the leaves with the stems for harvesting together, as shown in FIG. 3. In addition, the reel 104 has a variable speed so that slower or faster rotation varies the amount of leaves being removed.

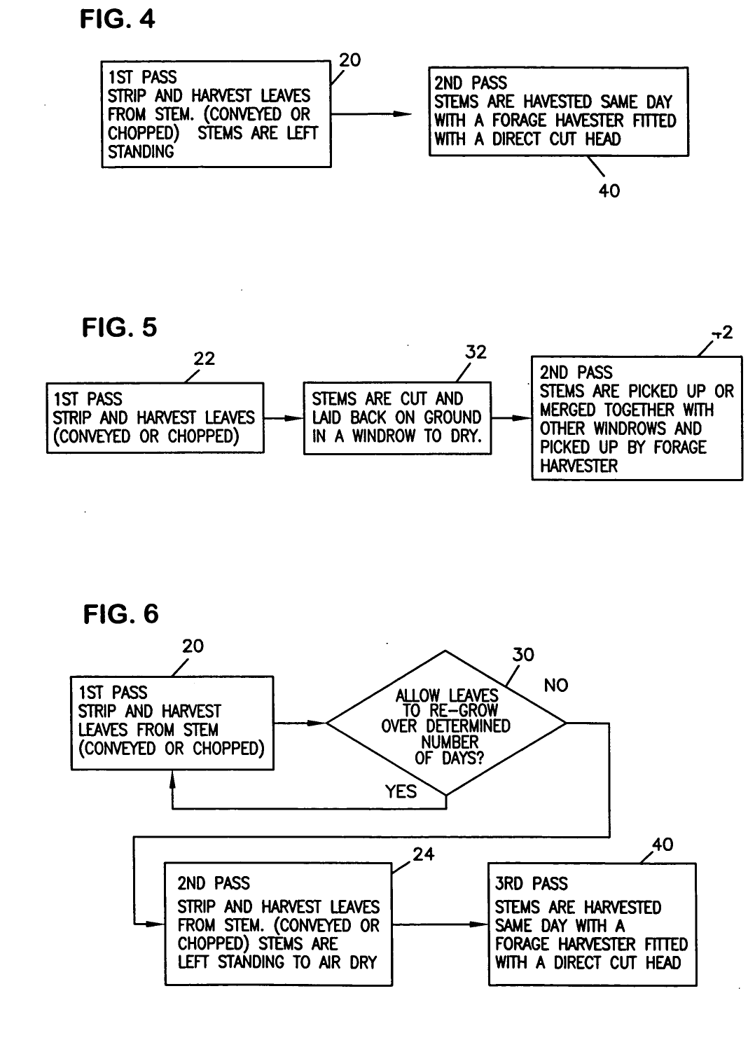

Referring now to FIGS. 4 -9, there are shown various methods according to the present invention for harvesting and managing a crop and optimizing the nutrient content when used as a livestock feed. The method of the present invention relates to harvesting separate portions of a crop, which have different nutritional contents, separately and then mixing the harvested portions having different content as necessary to arrive at a mixture having a desired nutritional content. Referring to FIG. 4, according to a first method, the leaves of a plant are stripped from their stem while the stems are left standing, as shown at step 20. The stems 1002 shown in FIG. 2 are allowed to air dry in the field for later harvesting as at step 30. In one embodiment, the stems are harvested on the same day such as being cut and picked up by a harvester having a direct cutting head at step 40. In this manner, it is possible to harvest the leaves in the morning, allow the stems to dry, and then harvest the stems later in the same day. As all steps may occur in one day, concerns such as rain and weather preventing drying, are less likely to ruin the crop while it is left in the field. Moreover, it has been found that the stems dry sufficiently in one day once the leaves are removed, rather than previous methods wherein the entire plants were cut and required several days to dry sufficiently.

Referring to FIG. 5, there is shown a second variation of the method according to the principles of the present invention. According to this method, the leaves are stripped and harvested at step 22 in a manner similar to that of FIG. 4. However, the stems are also cut and are allowed to fall to the ground and dry, as shown in step 32. The stems may then be picked up or merged into windrows and picked up by a forage harvester as in step 42. With both of the methods shown in FIGS. 4 and 5, all portions of the plants may be fully harvested in one day with the stems and the leaves separately harvested. Testing has shown that cut stems that have the leaves stripped from them and are allowed to dry for one day will dry faster than entire plants. It has been found that the stems will dry sufficiently and avoid the problems of the prior methods that require drying for several days.

Referring to FIG. 6, there is shown a further variation of a method of harvesting and managing harvested plants according to the principles of the present invention. As with the method shown in FIG. 4, in a first pass the leaves are stripped from the stem while the stems remain standing as at step 20. However, instead of harvesting the stems on the same day, the leaves are allowed to regrow on the stems. If desired, the regrown leaves may then be harvested again and the stripping and regrowth shown at steps 20 and 30 may be repeated several times in order to vary the ratio of harvested leaves to stems.

In a second pass, the leaves are stripped and harvested from the stems as at step 24 in a manner similar to step 20 with the stems left standing to air dry in a manner similar to step 40 shown in FIG. 4. The stems may then be cut and harvested when they are sufficiently dry. It has been found that steps 24 and 40 may again take place the same day. It can be appreciated that with the method shown in FIG. 6, a greater percentage of leaves may be obtained for a final mix than with the methods wherein leaves and stems are harvested at the same time. In addition, it has been found that the leaves may grow sufficiently and are ready for harvesting faster than previous methods wherein the stems and leaves are both cut and both the stem and the leaves must regrow. Moreover, at step 20 and/or step 24, it is possible to vary the percentage of the leaves that are removed, such as shown in FIGS. 2 and 3, to further vary the ratio of stems to leaves.

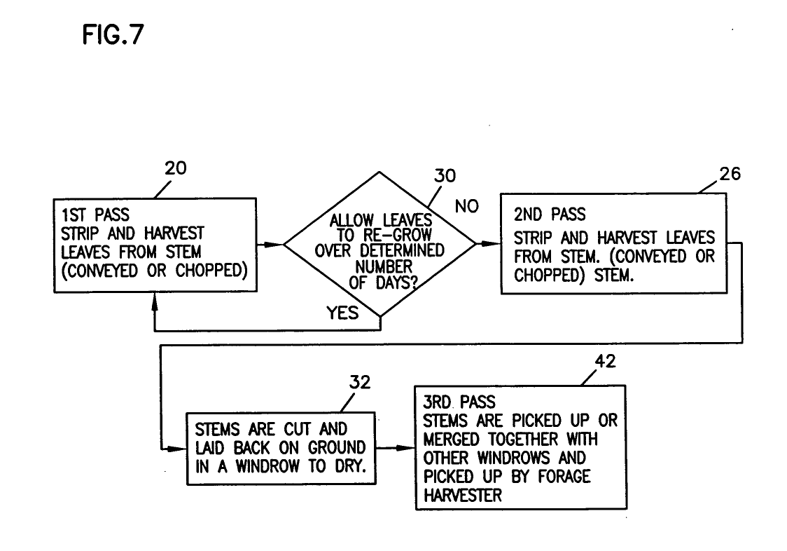

Referring now to FIG. 7, there is shown a still further variation of a method of harvesting and managing a crop used for livestock feed. As with the method shown in FIGS. 4 and 6, in a first step, the leaves are stripped from the stem while the stem is left uncut and standing. In a manner similar to that of FIG. 6, the leaves are then allowed to regrow, as shown at step 30. The leaves may be stripped again and regrown for one or more times to further vary the ratio of the leaves to stems. In addition, for all methods in which the leaves are regrown, the time that the leaves are allowed to regrow may be varied to change the size of the leaves. Changing the size of the leaves changes the mass of the leaves and the leaf to stem ratio. Steps 20 and 30 may occur several times until it is decided that the stems should also be harvested. As shown at step 26, the leaves may be stripped and harvested while the stems are cut and laid back on the ground and are windrowed and allowed to dry as shown in step 32. The stems are then merged together or picked up such as with a forage harvester shown at step 42. It can be appreciated that steps 26, 32 and 42 may all occur on the same day as with the method shown in FIG. 5. Moreover, the amount of leaves removed in steps 20 and 26 may be varied to further control the stem to leaf ratio.

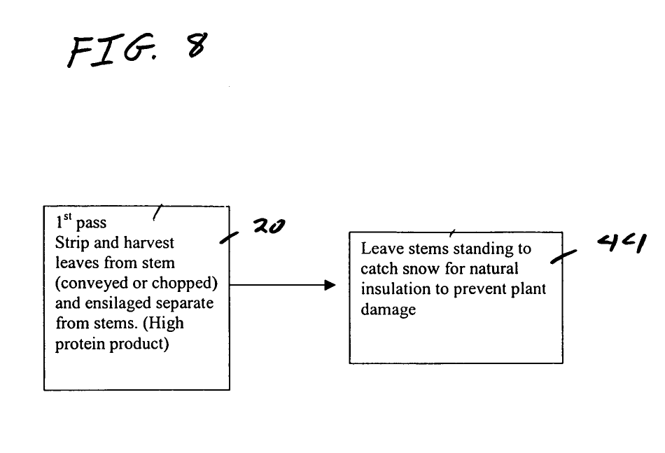

Referring now to FIG. 8 there is shown another variation of a method of harvesting according to the principles of the present invention. The method is typically utilized for the last harvesting of the year in cold weather climates. However, there may be other reasons to utilize this at other times and in other climates. Harvesting may continue utilizing the other methods or a combination of the other methods, leading up to an end of the year harvesting. As shown in FIG. 8, the leaves are stripped and harvested while the stems are left standing in the field. However, instead of cutting the stems, the stems are simply left standing in the field, as shown at step 44. The leaves may or may not regrow depending on conditions, but the standing stems typically attract snow and provide insulation to limit plant damage over the winter months. The combination of the various method steps during different times of the year along with the final method shown in FIG. 8 provide for optimization of the harvesting method and for additional harvest cycles to occur. As the leaves will typically regrow and be ready for harvesting faster than if the entire plant regrows a stem and leaves, additional harvests may occur throughout the year in the same period. In addition, the final harvesting typically occurs later in the year due to the ability to regrow only leaves and allow the stems to stay standing in the field. This provides for additional harvests and greater yield especially with regard to the harvested material containing the leaves.

It can be appreciated that with the present invention, greater control is possible as the leaves, such as alfalfa leaves, may be stored separately from the stems to achieve a high protein product, for example. The stems may be harvested separately and stored separately from the leaves to obtain a high fiber product. These separate products may then be mixed in varying ratios to achieve the protein and fiber contents required for individual animals or herds. Moreover, the stems and leaves may be mixed in varying ratios at the time of harvest or added to pure stems or leaves to optimize the fiber and protein product desired to meet the particular needs of the farmer. The present invention also eliminates the uncertainties with prior art methods wherein the plants would be cut and then required several days in the field to dry, suffering from the uncertainties of weather and the loss of some crop and time due to unexpected rain or having to wait for a stretch of several days having favorable conditions. By also varying the number of leaves that are stripped from the plant by varying the time that the leaves are allowed to regrow and by varying the number of harvestings of only leaves, mixes of stems and leaves across a broad spectrum are achieved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A method of harvesting a crop in a field, the crop having a stem and leaves, the method comprising:
stripping leaves from the stem at a first time; and
harvesting the stem at a second time after the first time.

2. A method according to claim 1, wherein the stem is cut at the first time and allowed to dry in the field until the second time.

3. A method according to claim 1, wherein the crop is alfalfa.

4. A method according to claim 1, wherein the crop is mint.

5. A method according to claim 1, wherein the crop is barley.

6. A method of harvesting a crop having leaves and a stem, comprising:
stripping the leaves from the stem at a first time, while leaving the stem standing;
allowing leaves to regrow on the stem;
stripping the leaves from the stem and cutting the stem;
allowing the stem to dry;
harvesting the stem.

7. A method according to claim 6, wherein the crop comprises alfalfa.

8. A method according to claim 6, wherein the stem is left in the field to dry.

9. A method of managing protein content of a crop having a first portion having a first nutritional content and a second portion having a second nutritional content, comprising:
removing the first portion of the crop from the second portion;
allowing the first portion to regrow and removing regrown first portions from the second portion a predetermined number of times;
harvesting the second portion a predetermined number of times during selected removing of the first portion; and
mixing a first amount of the first portion with a second amount of the second portion to achieve desired nutritional content.

10. A method according to claim 9, wherein the crop comprises alfalfa and the first portion comprises alfalfa leaves and the second portion comprises alfalfa stems.

11. A method according to claim 9, wherein the second portion is cut and dried in the field while harvesting the first portion.

12. A method according to claim 9, wherein the nutritional content comprises protein content.

13. A method of harvesting a crop, comprising:
harvesting a percentage of a first portion of a crop having a first nutritional content; harvesting a second portion of the crop having a second nutritional content separately from the first portion;
mixing a first amount of the first portion with a second amount of the second portion to achieve a desired nutritional content.

14. A method according to claim 13, wherein the first portion of the crop is cut at a first time and allowed to dry in the field until a second time when harvesting the second portion of the crop.

15. A method according to claim 13, wherein the first portion of the crop comprises leaves and the second portion of the crop comprises a stem.

16. A method according to claim 13, wherein the crop is alfalfa.

17. A method according to claim 13, wherein the crop is mint.

18. A method according to claim 13, wherein the crop is barley.
